(19) United States
(12) Patent Application Publication
(10) Pub. No.: US 2011/0182604 A1
(43) Pub. Date: Jul. 28, 2011

(54) IMAGE FORMING APPARATUS, IMAGE DENSITY CONTROL METHOD, CONTROL PROGRAM AND RECORDING MEDIUM

(76) Inventors: Masayuki OTSUKA, Osaka-shi (JP); Takashi Kitagawa, Osaka (JP); Katsuhiro Nagayama, Osaka (JP)

(21) Appl. No.: 13/014,196

(22) Filed: Jan. 26, 2011

(30) Foreign Application Priority Data
Jan. 27, 2010 (JP) 2010-014978

(51) Int. Cl. G03G 15/08

(52) U.S. Cl. 399/53

(57) ABSTRACT

An image forming apparatus includes: a developing unit forming a toner image on a photoreceptor drum; a photo sensor detecting the image density of the toner image; an operation unit calculating a relational equation between the measurement detected by the photo sensor and the development potential; a storage unit storing the relational equation; and a control unit setting up a corrected development potential to obtain a target image density for the developing unit, based on the image density of toner image patches. When high-density correction is performed, the control unit forms a multiple number of toner image patches on the photoreceptor drum based on the corrected development potential that was obtained at the time of the previous high-density correction, and sets up a corrected development potential for obtaining the target image density, based on the multiple image densities of the multiple toner image patches.

This Nonprovisional application claims priority under 35 U.S.C. §119(a) on Patent Application No. 2010-014978 filed in Japan on 27 Nov. 2010, the entire contents of which are hereby incorporated by reference.

### BACKGROUND OF THE INVENTION

(1) Field of the Invention

The present invention relates to an image forming apparatus, image density control method, control program and recording medium, in particular, relating to an image forming apparatus such as an electrostatic copier, laser printer, facsimile machine or the like, which produces a toner image by use of an electrophotographic technique by applying a development potential to a photoreceptor, image forming method, control program and recording medium for use in this image forming apparatus.

(2) Description of the Prior Art

Conventionally, image forming apparatuses based on electrophotography such as copiers, printers, facsimile machines and the like have been known. The image forming apparatus using electrophotography is constructed so as to form an image by forming an electrostatic latent image on the surface of an electrified photoreceptor (e.g., photoreceptor drum), supplying toner to the photoreceptor by means of a developing unit to develop the electrostatic latent image with toner, transferring the toner image formed on photoreceptor by development to a sheet of paper or the like, and fixing the toner image onto the sheet by means of a fixing device.

Electrification of the photoreceptor surface is performed by a charger that is applied with a charging bias (charging potential). The development of the electrostatic latent image is performed by applying a developing bias (development potential) to the developing unit.

In the image forming apparatuses of this kind, it happens that the resultant toner image varies in image density due to variation of ambient conditions around the apparatus, fatigue of the photoreceptor and the developer, and the like.

To deal with this, there is a known prior art technique of adjusting toner image density by changing the charging bias and the developing bias. That is, there has been disclosed a configuration in which a plurality of toner image patches are sequentially formed by changing the developing bias while the charging bias is set correspondingly to each developing bias in accordance with the attenuation characteristic of the surface potential of the photoreceptor under the influence of the exposure device, and the most suitable developing bias necessary for obtaining the target density is determined based on the image density of each patch (see Patent Document 1).

In this way, formation of multiple image patches on the photoreceptor by setting the charging bias in conformity with each developing bias based on the attenuation characteristic of the surface potential of the photoreceptor, makes it possible to determine the most suitable developing bias necessary for obtaining the target density on both the high and low density sides.

### Patent Document 1:

Japanese Patent Application Laid-open 2001-350300.

However, in order to deal with the recent trend toward high-definition image quality, it is necessary for the image forming apparatus to attain the target image density more precisely so as to provide high-quality images for the users. For this purpose, it is necessary to provide fine adjustment of the development potential to attain the target image density, hence the image forming apparatus of Patent Document 1 has not been sufficient enough for image density control to provide a further high-definition image.

That is, the high-density correction (high-density process control) process in the conventional image forming apparatus, in order to perform density detection, prepares several toner image patches with development potentials stepped at regular intervals so as to determine the development potential for the target density value.

However, this method entails the problem that it is impossible to achieve high-density correction with high precision, depending on the interval between sampling development potentials for creating the multiple toner image patches.

### SUMMARY OF THE INVENTION

The present invention has been devised in view of the above conventional problem, it is therefore an object of the present invention to provide an image forming apparatus, image density control method, control program and recording medium, which can determine a desired image density by improving the precision of image density detection around the target image density when toner image patches are detected.

In order to achieve the above object, the image forming apparatus, image density correcting method, control program and recording medium of the present invention are configured as follows:

According to the first aspect of the present invention, an image forming apparatus creating a toner image with an application of a development potential includes: a developing unit that forms a toner image on a photoreceptor under application of the development potential; a toner image density detector that detects the image density of the toner image formed as toner image patches on the photoreceptor; an operation unit that calculates a relational equation between the detected value detected by the toner image density detector and the development potential; a storage unit for storing the relational equation calculated by the operation unit; and a control unit that sets up the development potential calculated to obtain the target image density for the developing unit based on the relational expression, as a corrected development potential, and is characterized in that when high-density correction is performed, the control unit sets up a plurality of sampling development potentials for forming a plurality of toner image patches on the photoreceptor, using the corrected development potential obtained from the high-density correction that was executed immediately before, as the reference development potential, and the multiple sampling development potentials are distributed so that the difference between adjacent development potentials becomes smaller as each sampling development potential is closer to the reference development potential.

The second aspect of the present invention is characterized in that the multiple sampling development potentials are distributed so that the difference between adjacent sampling development potentials becomes greater as each sampling development potential goes away from the reference development potential.

The third aspect of the present invention is characterized in that the corrected development potential is calculated by the operation unit, and the time interval up to the next high-density correction is executed, is made shorter than the previously determined time interval when the corrected development potential does not take a value falling within the previously determined range of target development potential.

The fourth aspect of the present invention is characterized in that the relational equation is determined by the least squares method based on the multiple measurements detected by the toner image density detector and the corresponding multiple development potentials.

According to the fifth aspect of the present invention, an image density control method for an image forming apparatus that creates a toner image with an application of a development potential, includes: a developing step of forming a portion of toner image patches on a photoreceptor, with an application of a reference development potential stored in a storage unit and a plurality of sampling development potentials selected based on the reference development potential; a toner image density detecting step of detecting the image density of the multiple toner image patches; a relational equation calculating step of calculating the relational equation between the multiple measurements detected at the toner image density detecting step and the corresponding development potentials; a development potential calculating step of calculating as a corrected development potential, the development potential for obtaining the target image density based on the relational equation; and, a reference development potential rewriting step of rewriting the reference development potential stored in the storage unit with the corrected development potential.

The sixth aspect of the present invention is characterized in that the multiple sampling development potentials are distributed so that the difference between adjacent sampling development potentials becomes smaller as each sampling development potential is closer to the reference development potential.

The seventh aspect of the present invention is characterized in that the multiple sampling development potentials are distributed so that the difference between adjacent sampling development potentials becomes greater as each sampling development potential goes away from the reference development potential.

The eighth aspect of the present invention is characterized in that the time interval up to the next high-density correction is executed, is made shorter than the previously determined time interval when the corrected development potential does not take a value falling within the previously determined range of target development potential.

The ninth aspect of the present invention is characterized in that the relational equation is determined by the least squares method based on the multiple image densities detected by the toner image density detecting step and the corresponding multiple development potentials.

According to the tenth aspect of the present invention, a control program for causing the image forming apparatus defined in the above first to fourth aspects to operate, and is characterized in that a computer is made to function as the control unit.

The eleventh aspects of the present invention resides in a recording medium that is recorded with the control program defined in the above tenth aspect and readable by the computer.

According to the first aspect of the present invention, since the optimal development potential can be obtained by improving the image density detection accuracy around the target image density, it is possible to easily obtain the desired image density.

Also, according to the first aspect of the present invention, since the multiple sampling development potentials are distributed so that the difference between adjacent development potentials becomes smaller as each sampling development potential is closer to the reference development potential, a greater number of toner image patches can be created around the target image density and detected on image density. It is hence possible to achieve high-density correction with higher precision.

According to the second aspect of the present invention, it is possible to achieve high-density correction with higher precision, without creating a greater number of toner image patches than needed.

According to the third aspect of the present invention, the optimal development potential can be obtained in a short time by implementing the next high-density correction earlier than usual.

According to the fourth aspect of the present invention, the operation unit is made to determine the approximate equation using the least squares method based on the measurements detected by the toner image density detector and the corresponding development potentials. Accordingly, for example, the relationship between the toner image density and the development potential is approximated using the least squares method based on the measurement obtained by the toner image density detector (photo sensor) and the development potential (development bias), by the method of determining such coefficients as to minimize the sum of the squares of the deviations, or by performing approximation using the method. It is therefore possible to determine the approximate equation with precision and hence achieve image density detection with high accuracy.

According to the fifth aspect of the present invention, since the optimal development potential can be obtained by improving the image density detection accuracy around the target image density, it is possible to easily obtain the desired image density.

According to the sixth aspect of the present invention, since a greater number of toner image patches can be created around the target image density and detected on image density, it is possible to achieve high-density correction with higher precision.

According to the seventh aspect of the present invention, it is possible to achieve high-density correction effectively, without creating a greater number of toner image patches than needed.

According to the eighth aspect of the present invention, the optimal development potential can be obtained in a short time by implementing the next high-density correction earlier than usual.

According to the ninth aspect of the present invention, the approximate equation can be determined with precision by approximation using the least squares method based on, for example, the detected value obtained at the toner image density detecting step and the development potential by the method of determining such coefficients as to minimize the sum of the squares of the deviations, or by performing approximation using the method. It is hence possible to achieve image density detection with high precision.

According to the tenth aspect of the present invention, since the method of setting and controlling the optimal value of the target image density can be loaded and executed, it is possible to make this control method versatile.

According to the eleventh aspect of the present invention, for example, the program for use in an image forming apparatus, for setting and controlling the optimal value of the target image density by determining the relational equation between the image densities of the toner image patches on the photoreceptor detected by the toner image density detector such as a photosensor etc., and the development potentials, can be easily provided for control unit of the image forming apparatus.

### BRIEF DESCRIPTION OF THE DRAWINGS

FIG. 1 is an illustrative view showing an overall configuration of an image forming apparatus according to the embodiment of the present invention;

FIG. 2 is an illustrative view showing a developing unit and its peripheral configuration of the image forming apparatus;

FIG. 3 is a block diagram showing an electric configuration of the image forming apparatus;

FIG. 4 is an illustrative view showing the relationship between the density values of toner image patches and the development potentials in the image forming apparatus; and,

FIG. 5 is a flow chart showing the procedural sequence of high-density correction in the image forming apparatus.

### DESCRIPTION OF THE PREFERRED EMBODIMENTS

The embodiment of the present invention will hereinafter be described in detail with reference to the accompanying drawings.

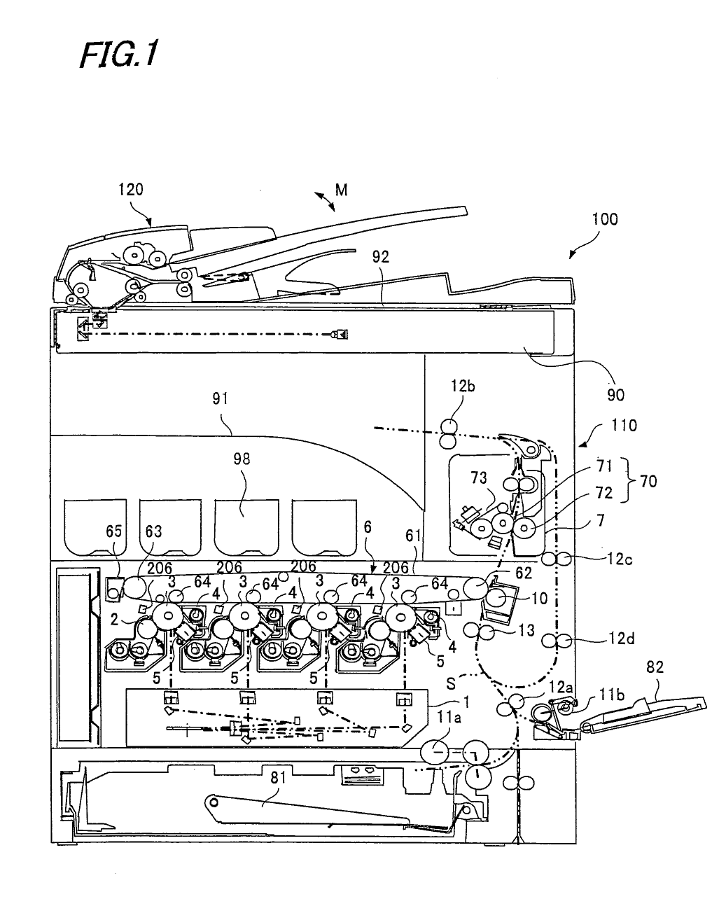

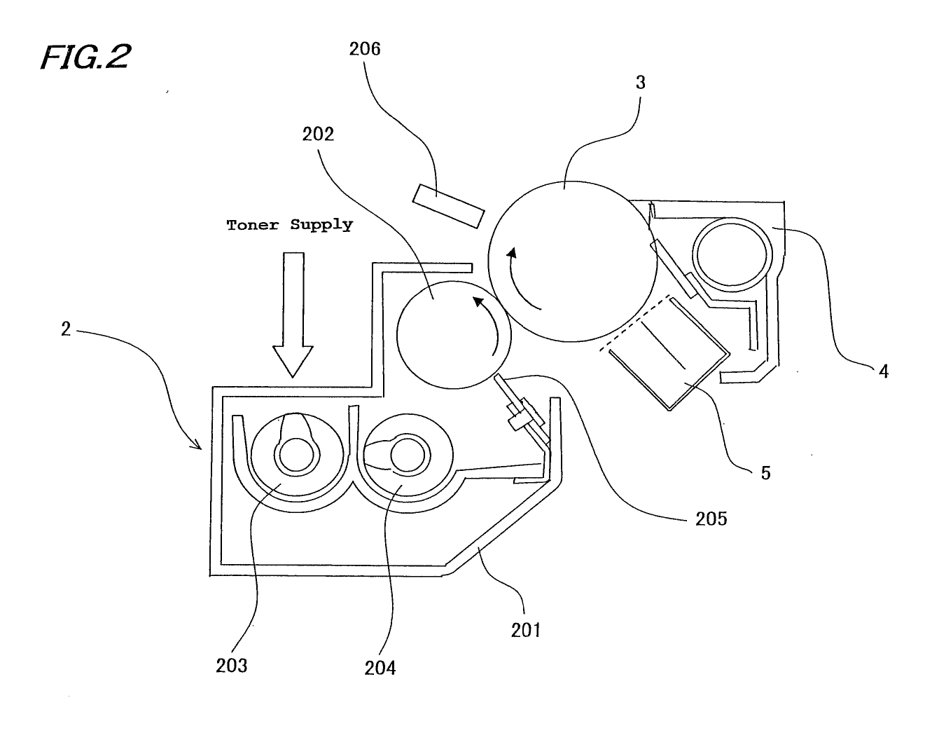

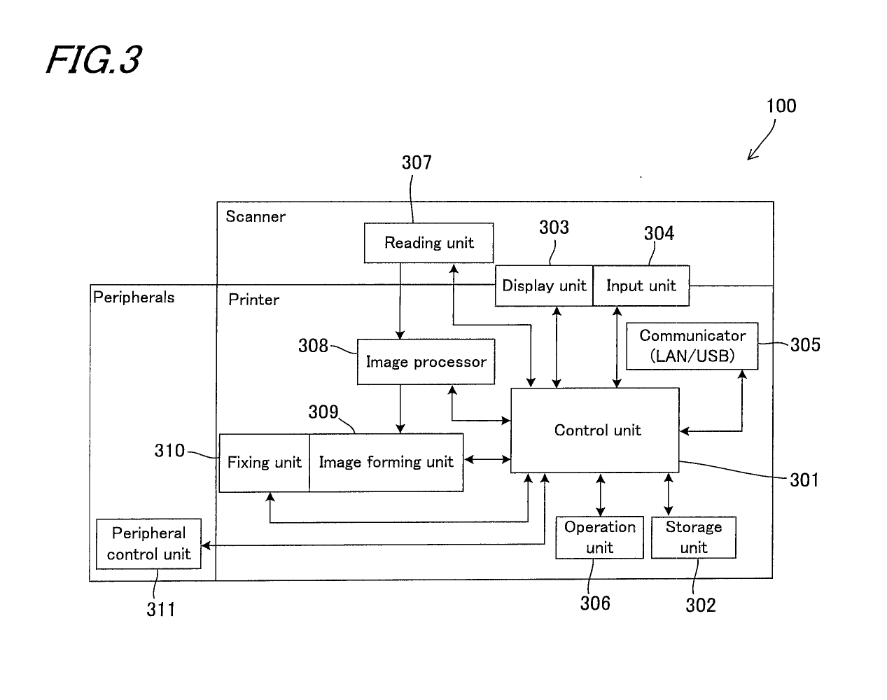

FIG. 1 shows one exemplary embodiment for carrying out the invention and is an illustrative view showing an overall configuration of an image forming apparatus according to the embodiment of the present invention. FIG. 2 is an illustrative view showing a developing unit and its peripheral configuration of the image forming apparatus. FIG. 3 is a block diagram showing an electric configuration of the image forming apparatus.

As shown in FIGS. 1 to 3, an image forming apparatus 100 of the present embodiment includes: a photoreceptor drum 3; a developing unit 2 having a development potential (developing bias) applied to form a toner image on photoreceptor drum 3; a photo sensor (toner image density detector) 206 for detecting the image density of the toner image formed as toner image patches on photoreceptor drum 3; an operation unit 306 for calculating a relational equation between the detected values detected by photo sensor 206 and the development potentials; a storage unit 302 for storing the relational equation calculated by operation unit 306; and a control unit 301 for setting the development potential for obtaining the target image density based on the toner patch image density, and forms a toner image by use of the development potential.

To begin with, the overall configuration of image forming apparatus 100 according to the first embodiment will be described.

As shown in FIG. 1, image forming apparatus 100 of the first embodiment can form a multi-colored or monochrome image on a predetermined sheet (e.g., recording paper) in accordance with externally transmitted image data, and is mainly composed of a main apparatus body 110 and an automatic document processor 120.

Main apparatus body 110 includes: an exposure unit 1; developing units 2, photoreceptor drums 3, cleaner units 4, chargers 5, an intermediate transfer belt unit 6, a fusing unit 7, a paper feed cassette 81, a paper output tray 91, a toner cartridge 98 and others.

Arranged on top of an image reader 90 in the upper part of main apparatus body 110 is a platen glass (document table) 92 made of a transparent glass plate on which a document is placed. On the top of platen glass 92, automatic document processor 120 is mounted.

Automatic document processor 120 automatically feeds documents onto document table 92.

This document processor 120 is constructed so as to be pivotable in the directions of bidirectional arrow M so that a document can be placed by hands by opening the top of platen glass 92.

The image data handled in image forming apparatus 100 is data for color images of colors, i.e., black (K), cyan (C), magenta (M) and yellow (Y).

Accordingly, four developing units 2, four photoreceptor drums 3, four chargers 5, four cleaner units 4 are provided to produce four electrostatic latent images corresponding to black, cyan, magenta and yellow. That is, four imaging stations are constructed thereby.

Charger 5 is applied with a charging bias (charging potential) from an unillustrated power supply so that the charging bias uniformly charges the photoreceptor drum 3 surface at a predetermined potential. Charger 5 may employ a corona-discharge type charger shown in FIG. 1. Other than this, contact type chargers, i.e., roller type and brush type chargers can also be used.

Exposure unit 1 is an image writing device that illuminates the electrified photoreceptor drums 3 in accordance with image data input from the outside or image data scanned from a document so as to from an electrostatic latent image corresponding to the image data on the photoreceptor drum 3 surfaces. Exposure unit 1 includes a LSU (laser scanning unit) having a laser emitter, reflection mirrors, etc. In this exposure unit 1, a polygon mirror for scanning a laser beam, optical elements such as lenses and mirrors for leading the laser beam reflected by the polygon mirror to photoreceptor drums 3 are laid out.

As exposure unit 1, techniques other than the above, i.e., methods using an array of light emitting elements such as an EL or LED writing head, for example may be used.

The thus constructed exposure unit 1 illuminates each of the electrified photoreceptor drums 3 with light in accordance with the input image data to form an electrostatic latent image corresponding to the image data on the surface of each photoreceptor drum 3.

Developing units 2 visualize the electrostatic latent images formed on photoreceptor drums 3 with four color (Y, M, C and K) toners.

Detailedly, developing unit 2 includes a developing vessel 201 for holding toner and a developing sleeve (developing roller) 202 for supplying the toner stored in developing vessel 201 to photoreceptor drum 3, as shown in FIG. 2.

Applied to developing sleeve 202 is a developing bias (development potential) from an unillustrated power supply. Developing sleeve 202 applied with the developing bias supplies toner from developing vessel 201 to the photoreceptor drum 3 surface so as to visualize (develop) the electrostatic latent image formed on photoreceptor drum 3.

Developing vessel 201 incorporates developer agitating rollers 203 and 204 for agitating and conveying toner. Developer agitating rollers 203 and 204 agitate and convey the developer including toner stored in developing vessel 201 and mixes up the toner supplied from the outside of developing vessel 201 with the developer.

The amount of toner supplied from developing sleeve 202 to photoreceptor drum 3 is regulated by a doctor blade 205 before the toner is supplied to photoreceptor drum 3.

Photoreceptor drums 3 each have a cylindrical form and are disposed over exposure unit 1 (FIG. 1). The surface of each photoreceptor drum 3 is cleaned by a cleaner unit 4 and the cleaned surface is then uniformly electrified by charger 5. Here, the photoreceptor is not limited to photoreceptor drum 3, but may use an endless photoreceptor belt.

Arranged near, or in proximity with the outer peripheral surface of, each photoreceptor drum 3 is a photosensor (toner image density detector) 206. This photosensor 206 detects the image density of toner image patches formed on photoreceptor drum 3.

Cleaner unit 4 removes and collects the toner left over on the photoreceptor drum 3 surface after development and image transfer.

Intermediate transfer belt unit 6 (FIG. 1) arranged over photoreceptor drums 3 is comprised of an endless intermediate transfer belt (endless belt) 61, an intermediate transfer belt drive roller 62, an intermediate transfer belt driven roller 63, intermediate transfer rollers 64 and an intermediate transfer belt cleaning unit 65. Four intermediate transfer rollers 64 are provided corresponding to four YMCK colors.

Intermediate transfer belt 61 is circulatively driven and supported by intermediate transfer belt drive roller 62, intermediate transfer belt driven roller 63 and intermediate transfer rollers 64.

Intermediate transfer belt 61 is given in the form of an endless film of about 100 μm to 150 μm thick and is arranged so as to contact with each photoreceptor drum 3. The toner images of different colors formed on photoreceptor drums 3 are sequentially transferred in layers to intermediate transfer belt 61, forming a color toner image (multi-color toner image) on intermediate transfer belt 61.

Transfer of toner images from photoreceptor drums 3 to intermediate transfer belt 61 are performed by intermediate transfer rollers 64 that are in contact with the rear side of intermediate transfer belt 61.

Specifically, each intermediate transfer roller 64 gives a transfer bias to intermediate transfer belt 61 so as to transfer the toner image on photoreceptor drum 3 onto intermediate transfer belt 61. Detailedly, a high-voltage transfer bias (high voltage of a polarity (+) opposite to the polarity (−) of the static charge on the toner) is applied intermediate transfer roller 64 in order to transfer the toner image.

Intermediate transfer roller 64 is a roller that is formed of a base shaft made of metal (e.g., stainless steel) having a diameter of 8 to 10 mm and a conductive elastic material (e.g., EPDM, foamed urethane or the like) coated on the shaft surface. This conductive elastic material enables uniform application of a high voltage to intermediate transfer belt 61. Though the transfer electrodes given in the form of rollers, i.e., intermediate transfer rollers 64, are used in the first embodiment, brushes and the like can also be used instead of these rollers.

The visualized toner images of colors on different photoreceptor drums 3 are laid over one after another on intermediate transfer belt 61 as stated above. The toner image formed as the lamination of image information is conveyed as intermediate transfer belt 61 moves, is transferred to the contact position with the paper (secondary transfer position or predetermined position) and transferred to the paper by a transfer roller 10 arranged at this contact position.

In this process, intermediate transfer belt 61 and transfer roller 10 are pressed against each other forming a predetermined nip while a secondary transfer bias for transferring the toner to the paper is applied to transfer roller 10. This secondary transfer bias is a high voltage of a polarity (+) opposite to the polarity (−) of the static charge on the toner.

Further, in order to constantly obtain the predetermined nip, either transfer roller 10 that is put in press-contact with intermediate transfer belt 61 at the secondary transfer position or intermediate transfer belt drive roller 62 that is put in press-contact with the rear side of intermediate transfer belt 61 at the secondary transfer position is formed of a hard material (metal or the like) while the other is formed of a soft material such as an elastic roller or the like (elastic rubber roller, foamed resin roller etc.).

Since, in the above transfer stage, the toner adhering to intermediate transfer belt 61 as the belt comes into contact with photoreceptor drums 3, or the toner which has not been transferred by transfer roller 10 to the paper and remains on intermediate transfer belt 61, would cause color contamination of toners in the toner image formed at the next operation, the remaining toner is removed and collected by intermediate transfer belt cleaning unit 65.

Intermediate transfer belt cleaning unit 65 is arranged at a position, along the path in which intermediate transfer belt 61 is conveyed, downstream of transfer roller 10 and upstream of photoreceptor drums 3 with respect to the intermediate transfer belt's direction of movement.

Intermediate transfer belt cleaning unit 65 includes a cleaning blade as a cleaning member that comes in contact with intermediate transfer belt 61 and cleans the surface of intermediate transfer belt 61. Intermediate transfer belt 61 is supported from its interior side by intermediate transfer belt driven roller 63, at the portion where the cleaning blade comes into contact with the belt.

Paper feed cassette 81 is a tray for stacking the paper to be used for image forming and is arranged under exposure unit 1 of main apparatus body 110. Also, a manual paper feed cassette 82 that permits the paper to be supplied from the outside is arranged outside main apparatus body 110.

This manual paper feed cassette 82 can also hold a plurality of sheets to be used for image forming. Arranged in the upper part of main apparatus body 110 is a paper output tray 91 which collects printed sheets facedown.

Main apparatus body 110 further includes a paper feed path S that extends approximately vertically to convey the paper from paper feed cassette 81 or manual paper feed cassette 82 to paper output tray 91 by way of transfer roller 10 and fixing unit 7. Arranged along paper feed path S from paper feed cassette 81 or manual paper feed cassette 82 to paper output tray 91 are pickup rollers 11a and 11b, a plurality of feed rollers 12a to 12d, a registration roller 13, transfer roller 10, fixing unit 7 and the like.

Feed rollers 12a to 12d are small rollers for promoting and assisting paper conveyance and are arranged along paper feed path S. Here, since feed roller 12b functions as a paper output roller for discharging the paper to paper output tray 91, it is called a paper output roller.

Pickup roller 11a is arranged near the end of paper feed cassette 81 so as to pick up the paper, one sheet at a time from paper feed cassette 81 and deliver it to paper feed path S.

Pickup roller 11b is arranged near the end of manual paper feed cassette 82 so as to pick up the paper, one sheet at a time from manual paper feed cassette 82 and deliver it to paper feed path S.

Registration roller 13 temporarily suspends the paper that is being conveyed along paper feed path S. This roller delivers the paper toward transfer roller 10 at such a timing that the front end of the paper will meet the front end of the toner image data area on intermediate transfer belt 61. In other words, transfer of the toner image from intermediate transfer belt 61 to the predetermined position of the paper being conveyed is adjusted by registration roller 13.

Fixing unit 7 includes pair of fixing rollers 70, namely, a heat roller 71 and a pressing roller 72. Heat roller 71 and pressing roller 72 are arranged so as to rotate and convey the sheet while nipping it therebetween.

Heat roller 71 and pressing roller 72 are arranged opposing each other, forming a fixing nip portion at the position where heat roller 71 and pressing roller 72 are put in press-contact with each other.

Heat roller 71 is temperature-controlled by control unit 301 (FIG. 3) so as to be set at a predetermined temperature. Heat roller 71 has the function of heating and pressing the toner to the paper in cooperation with pressing roller 72, so as to thermally fix the multi-color toner image transferred on the paper to the sheet by fusing, mixing and pressing it. The heat roller 71 is provided with an external heating belt 73 for fixing heat roller 71 from the outside, as shown in FIG. 1.

The sheet delivered from paper feed cassettes 81 or 82 is conveyed by feed rollers 12a on paper feed path S to registration roller 13, by which the paper is released toward transfer roller 10 at such a timing that the front end of the paper meets the front end of the image information on intermediate transfer belt 61 so that the toner image is transferred to the paper. Thereafter, the paper passes through fixing unit 7, whereby the unfixed toner on the paper is fused and fixed by heat. Then the sheet is discharged through feed rollers 12b arranged downstream, onto paper output tray 91.

The paper feed path S described above is that of the paper for a one-sided printing request. In contrast, when a duplex printing request is given, the paper that has been printed on its one side and passed through fixing unit 7, is held at its rear end by the final feed roller 12b. At this timing, the feed roller 12b rotates in reverse so as to lead the paper toward feed rollers 12c and 12d. Thereafter, the paper passes through registration roller 13 and is printed on its rear side and discharged onto paper output tray 91.

Next, the control system of image forming apparatus 100 of the present embodiment will be described in detail with reference to a block diagram.

As shown in FIG. 3, image forming apparatus 100 is a multi-functional machine including, for example a scanner, printer and other peripherals. The image forming apparatus includes, as its electric configurations, control unit (control means) 301 for controlling the operation of image forming apparatus 100, storage unit 302, a display portion 303, an input unit 304, a communicator 305 that controls LAN connection etc., with personal computers and the like via network lines, operation unit 306, a reading unit 307 for scanning document images, an image processor 308 for converting the scanned document images into appropriate electric signals to create image data, an image forming unit 309 for visualizing the created image data with toner and forming an image on the printing paper, fixing unit 310 for thermally fixing the toner image visualized through image forming unit 309, to the printing paper, and a peripheral control unit 311 for controlling a post-processor such as a finisher, sorter, etc., and other peripherals.

Input to control unit 301 can be a print command through the control panel (display portion 303, input portion 304) disposed on the top of image forming apparatus 100, detection result from unillustrated various sensors arranged at diverse sites inside image forming apparatus 100, image information input through unillustrated external devices (USB memory, LAN), various set values and data tables for controlling the operation of each unit inside image forming apparatus 100, programs for executing various kinds of control and other necessary data.

Storage unit 302 may use those usually used in the art. For example, read only memory (ROM), random access memory (RAM), hard disk drive (HDD) and the like can be listed. As the external devices, electric and electronic devices, that can form or acquire image information and be electrically connected to the image forming apparatus, can be used. Examples include computers, digital cameras, etc.

Operation unit 306 loads various kinds of data (print commands, detection result, image information, etc.) and programs for executing various kinds of control, stored in storage unit 302 and performs various kinds of detection and/or determination. Control unit 301, based on various kinds of determination results at operation unit 306, sends control signals to the corresponding units and performs operation control, in accordance with the operation result.

Control unit 301 and operation unit 306 are processing circuits that can be realized by a microcomputer, microprocessor or the like including a central processing unit (CPU), for example. The control system according to the present invention further includes a main power source in addition to storage unit 302, operation unit 306 and control unit 301. This main power source supplies power to not only the control system but also to each unit inside image forming apparatus 100.

Control unit 301 performs control for implementing high-density correction to determine the development potential (corrected development potential) for acquiring a toner image patch of a target image density. The target image density has been previously stored in storage unit 302, but may be permitted to be modified by a service person or user.

The high density correction includes a sampling toner patch image forming process and a development potential determining process.

The sampling toner patch image forming process is a process that forms a plurality of toner image patches on photoreceptor drum 3, using, as a development potential, the corrected development potential (reference development potential) obtained from the previous high-density correction, a plurality of sampling development potentials having potential differences from the reference development potential.

The multiple sampling development potentials are set such that the closer to the reference development potential the sampling development potential is, the smaller (narrower) the potential difference between the neighboring sampling development potentials whereas the farther from the reference development potential the sampling development potential is, the greater (wider) the potential difference between the neighboring sampling development potentials.

Further, the multiple sampling development potentials can be distributed on both the positive potential side and the negative potential side with respect to the reference development potential.

The development potential determining process is a process that sets (determines) the corrected development potential for obtaining the target image density based on the image densities of the multiple toner image patches formed at the sampling toner patch image forming process.

More specifically, operation unit 306 under control of control unit 301 determines an approximate equation of the relationship between the image density and the development potential, using the least squares method based on the multiple density measurements of multiple toner image patches detected by photosensor 206 and the multiple sampling development potentials, and calculates the corrected development potential for obtaining the target image density from the determined approximate equation.

Control unit 301 sets developing unit 2 with the corrected development potential determined by operation unit 306 and updates (rewrite) the reference development potential stored in storage unit 302 with the corrected development potential.

When the corrected development potential does not take a value falling within the predetermined target development potential range, control unit 301 makes the time interval (duration) until the next high-density correction is performed, shorter than the previously determined time interval. Here, the target development potential range has been previously stored in storage unit 302 (FIG. 3), but may be modified by a service person or user. The time interval (duration) up to the next execution of high-density correction is also stored beforehand in storage unit 302.

Next, high-density correction using toner image patches will be described.

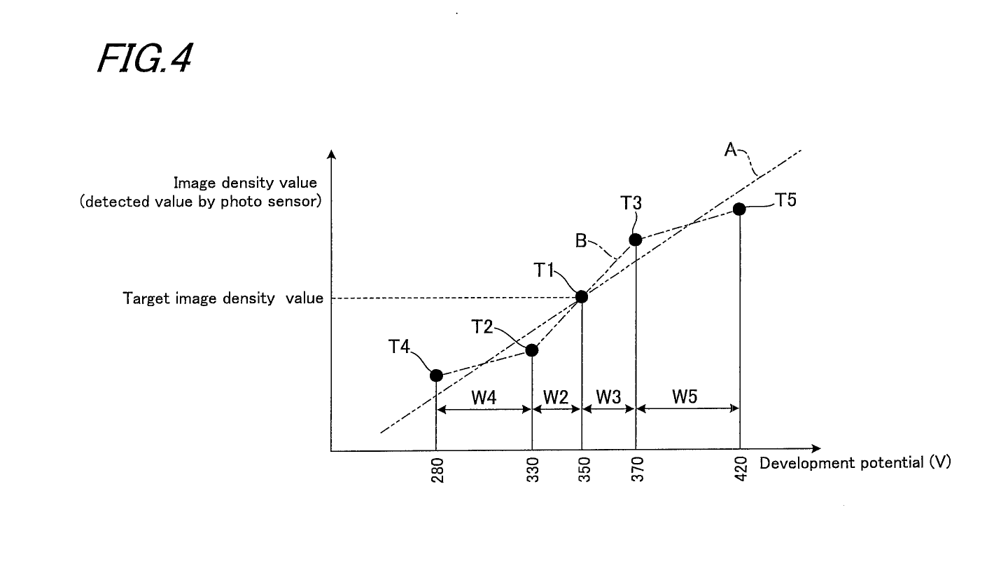

FIG. 4 is an illustrative view showing the relationship between the density values of toner image patches and the development potentials in the image forming apparatus of the present embodiment.

Image forming apparatus 100 sets a plurality of sampling development potentials based on the reference development potential stored in storage unit 302 to form a plurality of toner image patches on photoreceptor drum 3. Though, in this case, the charging bias of charger 5 is kept constant at the time of high-density correction, the charging bias may be changed for each of the reference development potential and sampling development potentials, in accordance with the attenuation characteristic of the surface potential of the photoreceptor.

FIG. 4 shows an example where five toner image patches are formed under control of control unit 301.

Toner image patch T1 in FIG. 4 is a toner image patch that is formed using 350 V, which is the sampling development potential (reference development potential), and is presumed to have an image density close to the target image density. Toner image patches T2 and T3 in FIG. 4 are toner image patches that are formed at first sampling development potentials 330V and 370V which are adjacent to the reference development potential on both the positive and negative sides. That is, the first development potential differences W2 and W3 of the first sampling development potentials from the reference development potential are −20V and +20V, respectively.

Toner image patches T4 and T5 in FIG. 4 are toner image patches that are formed at second sampling development potentials 280V and 420V which are adjacent to the first sampling development potentials 330V and 370V. The second development potential differences W4 and W5 of the second sampling development potentials from the corresponding first sampling development potential are −50 V and +50 V, respectively. That is, the second adjacent development potential differences W4 and W5 are set to be greater than the first adjacent development potential differences s W2 and W3.

In sum, the intervals between multiple sampling development potentials are designated so that W2<W4 and W3<W5 on the positive and negative sides with respect to the reference development potential. That is, the multiple sampling development potentials are distributed so that the adjacent development potential difference becomes greater as each sampling development potential goes away from the reference development potential (350V). It should be noted that the aforementioned number of sampling development potentials, the specific values of the reference development potential and sampling development potentials are given as mere examples and it goes without saying that the present invention should not be limited to these.

The thus prepared toner image patches T1, T2, T3, T4 and T5 are subjected to detection of photosensor 206 so as to obtain the image density of each of the toner image patches.

Then, in operation unit 306, the relational equation is determined based on the image densities of the acquired multiple (five, in this embodiment) toner image patches and corresponding multiple development potentials, and the corrected development potential is calculated from this relational equation.

In the present embodiment, operation unit 306 determines an approximate equation using the least squares method that performs least squares approximation of the entire points of measurement, based on the multiple measurements detected by the toner image density detector (photosensor 206) and corresponding multiple development potentials, so as to calculate the corrected development potential from the approximate equation A (the dashed and double-dotted line in FIG. 4). As another technique, it is also possible to calculate the corrected development potential by using linear interpolation that linearly connects one point to another adjacent point, as shown by a relational equation B (dash-dotted line in FIG. 4).

The high-density correction based on the image densities of toner image patches and development potentials as described above is repeatedly performed at intervals of a preset period of time.

However, if the corrected development potential calculated by operation unit 306 does not take a value falling within the target development potential range (i.e., the corrected development potential is greatly deviated from the previous result of high-density correction (reference development potential)), the time interval up to the implementation of the next high-density correction is adapted to be shortened.

Next, the sequence of high-density correction in image forming apparatus 100 of the present embodiment will be described using the flowchart.

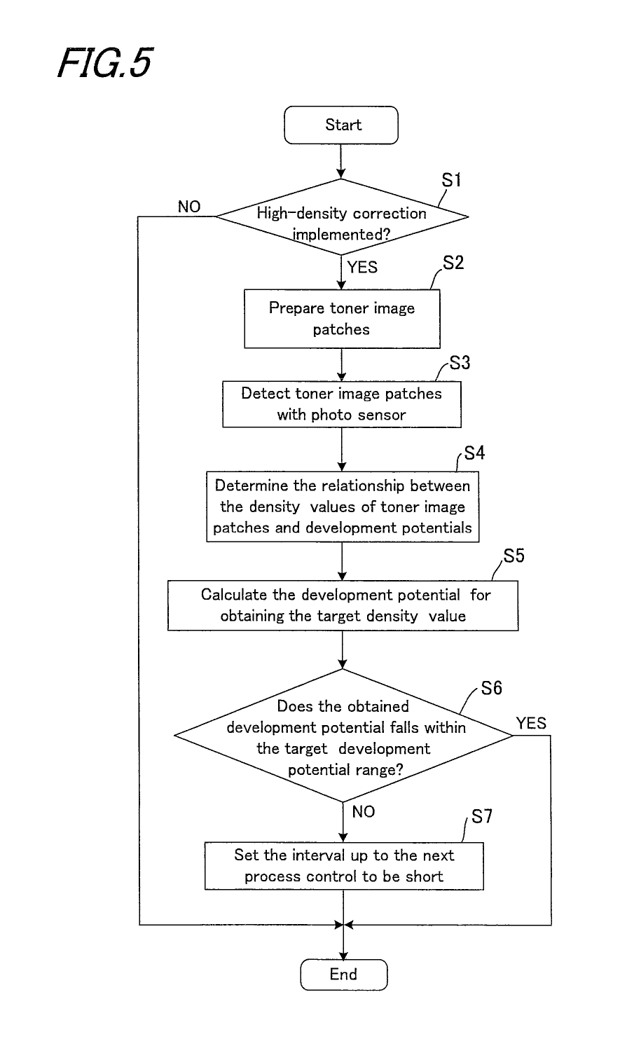

FIG. 5 is a flow chart showing the procedural sequence of high-density correction in the image forming apparatus of the present embodiment.

When high-density correction or a so-called process control is performed in image forming apparatus 100, control as shown in FIG. 5 is performed by control unit 301.

First, when it is determined at Step S1 that high-density correction has been done, a plurality of sampling development potentials are set up based on the reference development potential and a plurality of toner image patches are formed on photoreceptor drum 3, using the reference development potential and the multiple sampling development potentials (Step S2).

Then, the image density of each of the multiple toner image patches is detected by the toner image density detector, i.e., photosensor 206 (Step S3). Operation unit 306 determines an approximate equation based on the image densities of the multiple toner image patches detected by photosensor 206 and corresponding multiple development potentials (Step S4).

Thereafter, the corrected development potential is calculated from the approximate equation (Step S5), then it is determined whether the value of the corrected development potential falls within the target development potential range (Step S6).

When it was determined at Step S6 that the value of the corrected development potential is within the target development potential range, the target development potential is obtained so that high-density correction is ended.

On the other hand, when it was determined at Step S6 that the value of the corrected development potential is out of the target development potential range, the control unit sets the time interval up to the next high-density correction to be shorter than the predetermined time interval (Step S7) and ends the high-density correction. In this way, the optimal development potential can be obtained in a short time by implementing the next high-density correction earlier than usual.

According to the present embodiment thus configured, when high-density correction is implemented in image forming apparatus 100, control unit 301 forms a plurality of toner image patches T1, T2, T3, T4 and T5 on photoreceptor drum 3, based on the corrected development potential (reference development potential) obtained by the previous high-density correction, and operation unit 306 determines an approximate equation based on the toner patch image density of multiple toner image patches T1, T2, T3, T4 and T5 and their corresponding development potentials and sets up a corrected development potential for obtaining the target image density based on the approximate equation. It is hence possible to improve the image density detecting accuracy around the target image density and obtain the optimal corrected development potential. As a result, it is possible to obtain the desired image density in a simple manner.

Further, according to the present embodiment, since a multiple number of toner image patches are formed by setting multiple sampling development potentials at narrower intervals as the potential is closer to the reference development potential that is presumed to produce an image density close to the target image density, it is possible to further improve the image density detecting accuracy around the target image density. On the other hand, a multiple number of toner image patches are formed by setting multiple sampling development potentials at wider intervals as the potential goes farther away from the reference development potential that is presumed to produce an image density close to the target image density. Accordingly, it is possible to calculate the approximate equation more precisely.

Moreover, according to the present embodiment, when the value of the corrected development potential obtained by high-density correction falls out of the predetermined range of the target development potential, control unit 301 sets the time interval up to the next implantation of high-density correction to be shorter than the previously set time interval. This enables execution of high accuracy high-density correction in a short time.

Though in the present embodiment, the processing function for implementing high-density correction is provided for control unit 301 and operation unit 306 of image forming apparatus 100, the present invention should not be limited to this. The processing function for implementing high-density correction may also be realized by software.

That is, the software is used in a configuration including a CPU (central processing unit) for implementing commands of control programs executing diverse functions, ROM (read only memory) storing the programs, RAM (random access memory) for expanding the programs, storage devices (recording mediums) such as memory devices for storing the programs and various kinds of data and the like.

Also, a recording medium in which the program codes (executable program, intermediate code program, source program) of the control programs as the software for realizing the aforementioned functions are recorded in a computer-readable manner, maybe imparted to the image forming apparatus, so that the computer (or CPU or MPU) built in the image forming apparatus can load the program codes recorded in the recording medium to thereby execute the above-described high-density correction.

Examples of the above-described recording medium include: tape media such as magnetic tape, cassette tape, etc., disk media such as magnetic disks including floppy (registered trademark) disks, hard disks, etc., optical disks including CD-ROM, MO, MD, DVD, CD-R, etc., card media such as IC cards (including memory cards), optical cards, etc., semiconductor memory devices such as mask ROM, EPROM, EEPROM, flush ROM, etc.

Further, the image forming apparatus is constructed so as to be connectable to a communication network so that the program codes are imparted via the communication network. This communication network is not particularly limited. For example, the internet, intranet, extranet, LAN, ISDN, VAN, CATV communication network, virtual private network, telephone lines, mobile communication network, satellite communication network and the like are available.

Transmission medium constituting the communication network is not particularly limited. For example, wired cables such as IEEE1394, USB, power-line carrier, cable TV line, telephone line, ADSL line, etc., and wireless cables, such as IrDA and R/C using infrared rays, Bluetooth (registered trademark), 802.11 wireless network, HDR, mobile phone network, satellite line, terrestrial digital network, etc. may be used.

Also, the present invention can be realized even in the form of a computer data signal that is embedded in a carrier wave and embodies the program codes by electronic transmission.

Having described the preferred embodiment of the present invention, the present invention should not be limited to the above embodiment and other examples and various changes can be made within the range specified in the scope of claims. That is, any embodied mode obtained as appropriate by combination of technical means disclosed in the above embodiment should be included in the technical art of the present invention.

For example, in the above embodiment, the present invention is applied to a color image forming apparatus (multi-functional machine, printer, etc.), however the present invention can also be applied to other image forming apparatuses such as a monochrome image forming apparatus and the like.

What is claimed is:

1. An image forming apparatus creating a toner image with an application of a development potential, comprising:
a developing unit that forms a toner image on a photoreceptor under application of the development potential;
a toner image density detector that detects the image density of the toner image formed as toner image patches on the photoreceptor;
an operation unit that calculates a relational equation between the detected value detected by the toner image density detector and the development potential;
a storage unit for storing the relational equation calculated by the operation unit; and,
a control unit that sets up the development potential calculated to obtain the target image density for the developing unit based on the relational expression, as a corrected development potential,
characterized in that when high-density correction is performed, the control unit sets up a plurality of sampling development potentials for forming a plurality of toner image patches on the photoreceptor, using the corrected development potential obtained from the high-density correction that was executed immediately before, as the reference development potential, and
the multiple sampling development potentials are distributed so that the difference between adjacent development potentials becomes smaller as each sampling development potential is closer to the reference development potential.

2. The image forming apparatus according to claim 1, wherein the multiple sampling development potentials are distributed so that the difference between adjacent sampling development potentials becomes greater as each sampling development potential goes away from the reference development potential.

3. The image forming apparatus according to claim 1, wherein the corrected development potential is calculated by the operation unit, and,
the time interval up to the next high-density correction is executed, is made shorter than the previously determined time interval when the corrected development potential does not take a value falling within the previously determined range of target development potential.

4. The image forming apparatus according to claim 1, wherein the relational equation is determined by the least squares method based on the multiple measurements detected by the toner image density detector and the corresponding multiple development potentials.

5. An image density control method for an image forming apparatus that creates a toner image with an application of a development potential, comprising:
a developing step of forming a portion of toner image patches on a photoreceptor, with an application of a reference development potential stored in a storage unit and a plurality of sampling development potentials selected based on the reference development potential;
a toner image density detecting step of detecting the image density of the multiple toner image patches;
a relational equation calculating step of calculating the relational equation between the multiple measurements detected at the toner image density detecting step and the corresponding development potentials;
a development potential calculating step of calculating as a corrected development potential, the development potential for obtaining the target image density based on the relational equation; and,
a reference development potential rewriting step of rewriting the reference development potential stored in the storage unit with the corrected development potential.

6. The image density control method according to claim 5, wherein the multiple sampling development potentials are distributed so that the difference between adjacent sampling development potentials becomes smaller as each sampling development potential is closer to the reference development potential.

7. The image density control method according to claim 5, wherein the multiple sampling development potentials are distributed so that the difference between adjacent sampling development potentials becomes greater as each sampling development potential goes away from the reference development potential.

8. The image density control method according to claim 5, wherein the time interval up to the next high-density correction is executed, is made shorter than the previously determined time interval when the corrected development potential does not take a value falling within the previously determined range of target development potential.

9. The image density control method according to claim 5, wherein the relational equation is determined by the least squares method based on the multiple image densities detected by the toner image density detecting step and the corresponding multiple development potentials.

10. A control program for causing the image forming apparatus according to claim 1 to operate, characterized in that a computer is made to function as the control unit.

11. A recording medium that is recorded with the control program according to claim 10 and readable by the computer.
